(19) United States
(12) Patent Application Publication
(10) Pub. No.: US 2007/0127696 A1
(43) Pub. Date: Jun. 7, 2007

(54) Systems, methods and devices to mask private data displayed by a set-top box

(76) Inventor: Scott White, Austin, TX (US)

Correspondence Address: MATTHEW E. BURR;LAKE AUSTIN MARINA, 2219 WESTLAKE DR, STE 200, AUSTIN, TX, 78746, US

(21) Appl. No.: 11/295,157

(22) Filed: Dec. 6, 2005

(51) Int. Cl. H04M 3/00; H04M 5/00

(52) U.S. Cl. 379/265.09

(57) ABSTRACT

A user's personal data that may accessible on a remote terminal, such as a remote customer service representative's (CSR) terminal, is masked to provide privacy while allowing the CSR substantially full remote access to a user interface. “Masking” may refer to replacing or substituting an initial content description in an information field with a second content description. Preferably, the second content description preserves the user's privacy by disguising the description of the user's information or by providing a merely generic description of the information.

### FIELD OF THE DISCLOSURE

The present disclosure relates to telecommunications and, in particular, to remote access over a network to a subscriber's set-top box for customer service.

### BACKGROUND

Some Internet-enabled entertainment services, facilitated by Set-Top Boxes (STBs) either owned by the consumer or leased from the service provider, may allow both storage of personal user data (such as photos, songs and downloaded movies) and remote access to the STB by customer service representatives (CSR) in the context of a telephone support call such as, for example, the CSR walking the user through a function or resetting the STB software.

The ability of a service representative to remotely navigate the user's STB, and therefore view the user's personal media, creates privacy concerns. Limiting the representative's access to only certain portions of the STB software interface, however, also limits the representative's ability to fully assist users with problems.

### BRIEF DESCRIPTION OF THE DRAWINGS

The present invention is further described in the detailed description that follows, by reference to the noted drawings, by way of non-limiting examples of embodiments of the present invention, in which reference numerals represent the same parts throughout the several views of the drawings, and in which:

FIG. 1A is a drawing of an exemplary typical display of subscriber data from a set-top box on a television screen.

FIG. 1B is a drawing of the exemplary display of FIG. 1A showing masked private subscriber data.

FIG. 2 is a process flow diagram for a specific exemplary embodiment of the present disclosure.

FIG. 3 is a diagrammatic illustration of a system of a specific exemplary embodiment of the present disclosure.

FIG. 4 is a diagrammatic illustration of a system of an alternative specific exemplary embodiment of the present disclosure.

FIG. 5A is a diagrammatic illustration of an alternative specific exemplary embodiment of the present disclosure.

FIG. 5B is a diagrammatic illustration of another alternative specific exemplary embodiment of the present disclosure.

FIG. 6 is a diagrammatic representation of a machine in the form of a computer system 600 within which a set of instructions, when executed, may cause the machine to perform any one or more of the methodologies of the present disclosure.

### DETAILED DESCRIPTION

In view of the foregoing, the present disclosure, through one or more various aspects, embodiments and/or specific features or sub-components, is thus intended to bring out one or more of the advantages that will be evident from the description. The terminology, examples, drawings and embodiments, therefore, are illustrative and not intended to limit the scope of the disclosure.

The present disclosure addresses privacy concerns while substantially preserving functional remote access to the STB software interface by a CSR. Embodiments of the present disclosure may facilitate substantially full remote access to relevant portions of the Customer Premise Equipment (CPE) while seeking to protect the privacy of the user's personal media. From a terminal at a remote location, a CSR may navigate an STB software interface in the same way as the user, which may facilitate communication between the customer and the service representative. The representative may be able to resolve the user's technical issue in a relatively more expedient manner and in a way which is clearer to the user.

Instead of making portions of information on the STB unavailable to the representative, the present disclosure describes masking the user's personal data to provide privacy while allowing a CSR substantially full remote access to a user interface. Within the service representative's remote access interface, any private user data may be replaced with generic names or images. For instance, a specific movie title may be replaced with ‘Downloaded Movie,’ personal photos may be replaced with a generic photo or image, and so forth.

During a service call, a CSR may remotely navigate through an STB interface, to enhance their ability to help the user. The user's or subscriber's personal data may be substantially protected from the service representative's view.

Optionally, alternative embodiments provide for the remote service representative to obtain verbal permission from the user to view the actual data. Such verbal permission may be provided on an item-by-item basis (e.g., “Do I have your permission to see the title of the third item from the top?”), on a section-by-section basis (e.g., unmask all the titles in Movies), or on a global basis (all data unmasked throughout the interface or throughout a currently displayed set of information fields in the interface).

Customer Care interfaces may allow direct remote manipulation of the properties of a user's Customer Premise Equipment (CPE). Typical interfaces, however, may either allow the CSR to see the user's private data, which is a privacy concern, or forbid access to data stores, which limits the representative's ability to fully troubleshoot the user's issue.

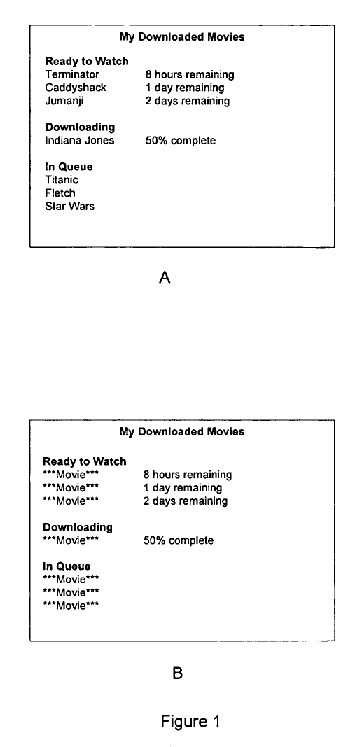

Turning now to the drawings, FIG. 1A is a drawing of an exemplary typical display of subscriber data from a set-top box on a television screen. The display of FIG. 1A relates in particular to subscriber movie download purchases. Categories of information on the display may include (1) “Ready To Watch” which may include information fields for movies that are downloaded and ready to viewed by the subscriber, together with the title of each downloaded movie and information about the time remaining before the downloads are deleted; (2) “Downloading” which may include information fields for movies that are presently being download together with the title of the movie and information about the status of the download progress; and (3) “In Queue” which may include information fields for movies that are scheduled to be downloaded, including the title of the scheduled movies. Subscriber data that is displayed may drawn from a local or a remote database, depending on the set-up configuration established by the service provider or selected by the customer.

FIG. 1B is a drawing of the exemplary display of FIG. 1A from a set-top box on a television screen having private subscriber data masked as described in a specific exemplary embodiment of the present disclosure. The titles of the movies have been replaced with generic information. The term “masking” may, therefore, refer to replacing or substituting an initial content description in an information field with a second content description. Preferably, the second content description preserves the user's privacy by disguising the description of the user's information or by providing a merely generic description of the information.

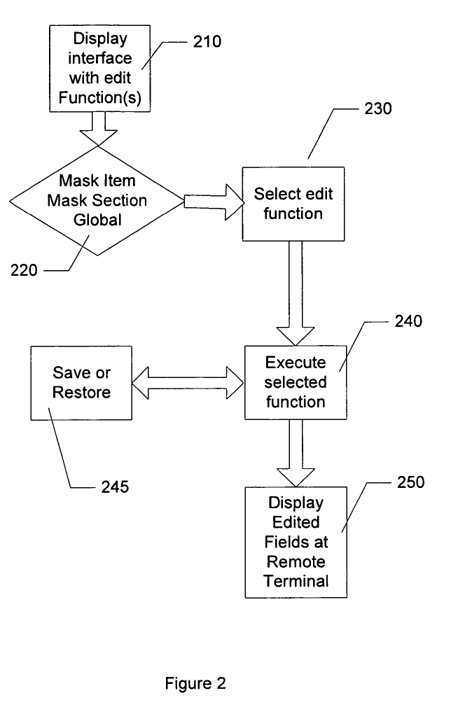

FIG. 2 is a process flow diagram for a specific exemplary embodiment of the present disclosure. One step of a process of the present disclosure may include displaying at a subscriber's local terminal (such as a television connected to a set-top box) a user interface 210 with edit functions to edit information such as private information of the user, particularly private information that relates to the subscriber's service account. The user interface may include a menu 220, for example, of selectable edit functions to facilitate masking the user's private information. Edit functions of the menu may include, for example, a “Mask Item” option to edit or mask a single selected item displayed on the user interface. “Mask Section” may allow an entire section of information fields to be masked. Here, “Mask Section” has been selected 230 and the interface highlights the selection. Menu 220 may be navigated by the user with, for example, a set-top box remote control.

Continuing with FIG. 2, another step of the process may include executing 240 the selected edit function 230 to mask one or more selected information fields on the user interface. The process may include displaying the masked information at a remote display 250, such as the computer monitor of a customer service representative of the service provider.

Additional features 245 of the present disclosure may include a function to save the masked information on a machine-readable medium, for example, or to restore masked information to its unmasked state. The latter feature may be advantageous to permit optionally selective unmasking of user information in the event that remote display of unmasked information from masked information, even on the fly during a service call, may be desired.

Masking a content description may refer to automatically substituting one description of the content with another description based, for example, on the content category. Content may be categorized, for instance, as a movie, as music, as an image, and so forth. Accordingly, the description of an individual item, such as its title or name, may be masked with an automatic replacement of the title with a generic description such as “movie” or “song.” Alternative embodiments further allow masking of information such as the cost of an item, which may preserve user privacy in instances where the nature of the content may be deduced from its price.

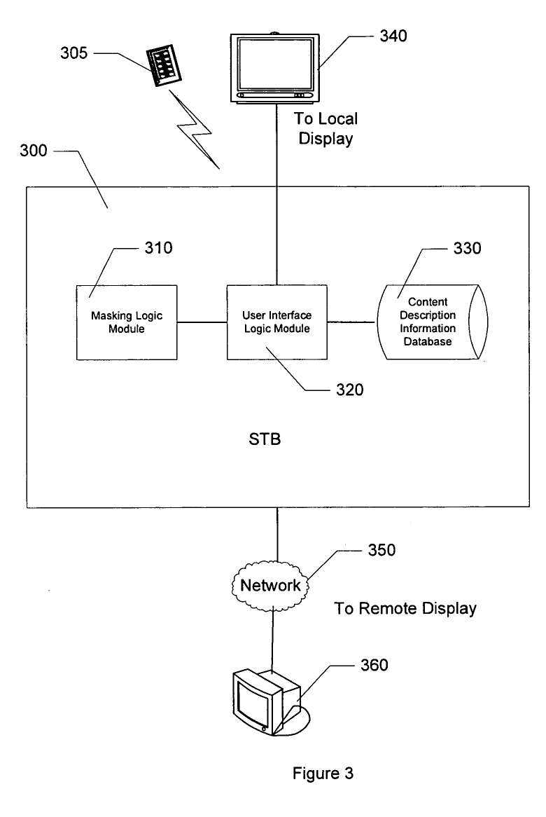

FIG. 3 is a diagrammatic illustration of a system of a specific exemplary embodiment of the present disclosure. Set-top box (STB) 300, for example, may house masking logic module 310 in communication with user interface logic module 320. User interface logic module 320 may be in communication with user information such as information field content description data 330 to display user information at a user's local display 340 for editing or masking content descriptions in a user interface displayed at a user's local display 340 and mediated by user interface logic module 320. The user interface at display 340 may be navigated, for example, by a user with an STB remote control device 305. Execution of one or more masking commands from the user interface may be mediated by masking logic module 320. Masked content descriptions may be displayed via network 350 at a remote display 360, such as a customer service representative terminal.

In certain embodiments, the masked content descriptions displayed at remote terminal 360 and the like may be “read-only.” That is, the CSR, for example, may only be able to view a subscriber's account information, but not edit the information. In other embodiments, the user interface at remote terminal 360 may allow the CSR to navigate through a subscriber's information with varying degrees of interactivity while still maintaining the masked content descriptions throughout the user interface.

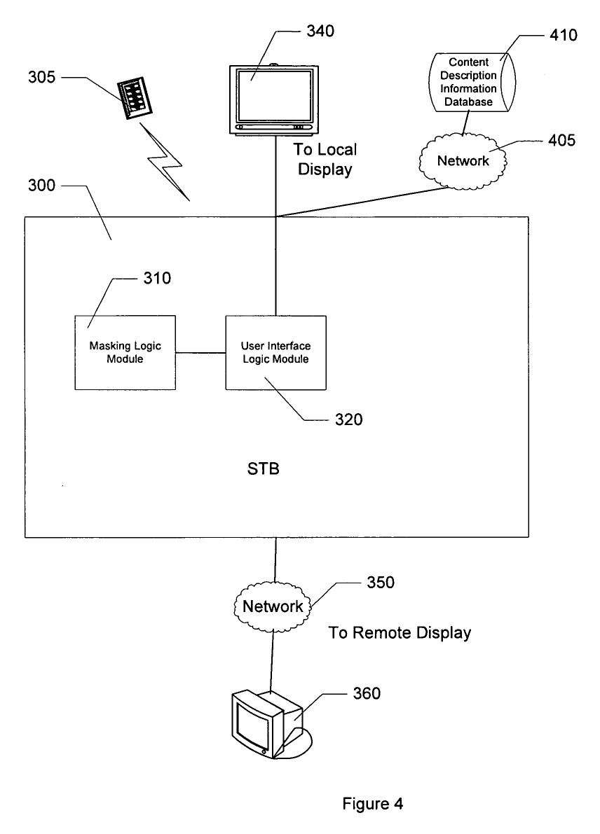

FIG. 4 is a diagrammatic illustration of a system of an alternative specific exemplary embodiment of the present disclosure. The system of FIG. 4 is similar to that of FIG. 3 but shows an alternative embodiment where content description data, or other user information, may be stored on a machine-readable medium 410 remote from STB 300 and in communication with STB 300 through network 405.

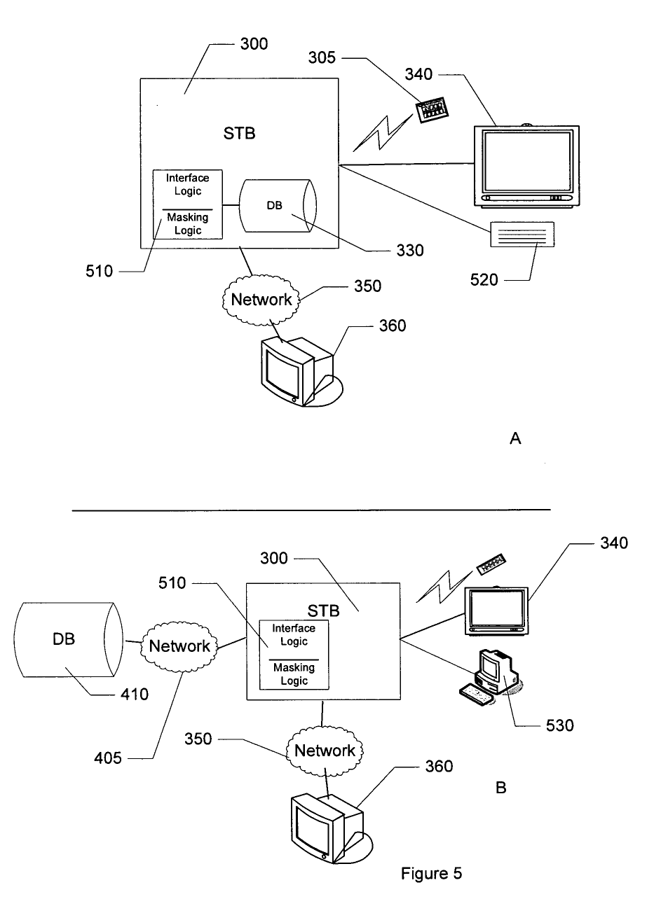

FIG. 5A is a diagrammatic illustration of an alternative specific exemplary embodiment of the present disclosure. FIG. 5B is a diagrammatic illustration of another alternative specific exemplary embodiment of the present disclosure. Masking and interface logic 510 may be housed in STB 300. Alternative embodiments of FIGS. 5A and 5B may allow the user to edit the content description to create a customized masking description, rather than accepting an automatic masking description. Such customization embodiments may provide a user interface with an on-screen virtual keyboard, for example, navigable with set-top box remote control 305 to edit the content of a selected information field. Embodiments of FIG. 5A, however, may provide a set-top box adapted to accept input from an actual keyboard 520 connected to STB 300, or, as shown in FIG. 5B, from a user's personal computer 530, for example, connected to STB 300.

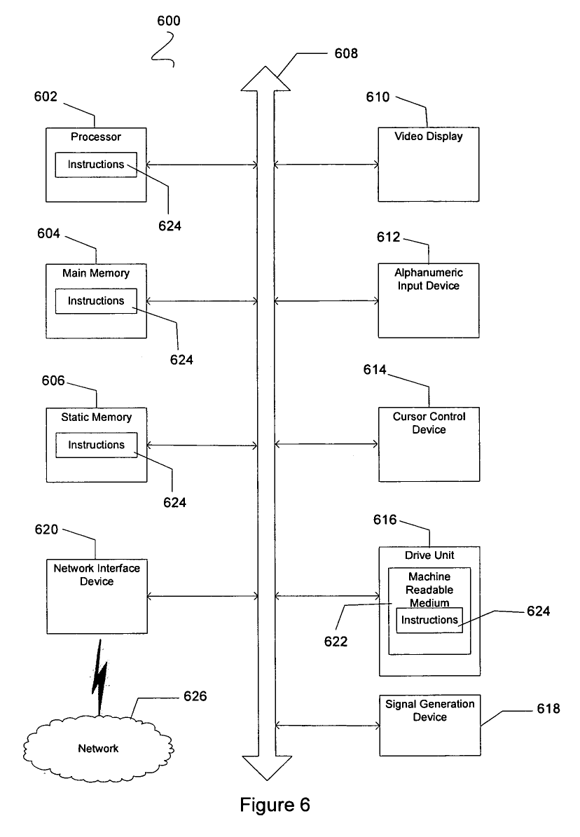

In accordance with various embodiments of the present disclosure, the methods described herein are intended for operation as software programs running on a programmable machine such as a computer processor. FIG. 6 is a diagrammatic representation of a machine in the form of a computer system 600 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU), or both), a main memory 604 and a static memory 606, which communicate with each other via a bus 608. The computer system 600 may further include a video display unit 610 (e.g., a liquid crystal display (LCD), a flat panel, a solid state display, or a cathode ray tube (CRT)). The computer system 600 may include an input device 612 (e.g., a keyboard), a cursor control device 614 (e.g., a mouse or a set-top box remote control), a disk drive unit 616, a signal generation device 618 (e.g., a speaker or remote control) and a network interface device 620.

The disk drive unit 616 may include a machine-readable medium 622 on which is stored one or more sets of instructions (e.g., software 624) embodying any one or more of the methodologies or functions described herein, including those methods illustrated in herein above. The instructions 624 may also reside, completely or at least partially, within the main memory 604, the static memory 606, and/or within the processor 602 during execution thereof by the computer system 600. The main memory 604 and the processor 602 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. The invention is considered to include a tangible storage medium or distribution medium, including a propagated signal, as listed herein and including art-recognized equivalents and successor media, in which the software implementations herein are stored.

Those skilled in the art will recognize that the present invention extends to machine-readable media (“MRM”) contain instructions for execution by a programmable machine such as a computer. MRM is broadly defined to include any kind of computer memory such as floppy disks, conventional hard disks, CD-ROMs, Flash ROMS, nonvolatile ROM, RAM, Storage Media, email attachments, solid state media, magnetic media, and signals containing instructions, together with processors to execute the instructions.

The term “machine-readable medium” shall accordingly be taken to further include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus the following claims are hereby incorporated into the Detailed Description, with each claim standing on its own as a separate embodiment.

The invention has been described with reference to several exemplary embodiments. It is understood, however, that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

I claim:

1. A machine-readable medium containing instructions that, when executed by a machine in communication with a database and with a display, the instructions cause the machine to:
display a user interface having:
one or more selectable information fields containing one or more initial descriptions of the content of the database; and
one or more selectable information masking functions to mask the initial content description in one or more selected information fields; and
execute one or more selected masking functions to mask the initial content description in one or more selected information fields.

2. The medium of claim 1, wherein one or more of the selected masking functions comprise replacing one or more of the initial content descriptions with at least one replacement content description.

3. The medium of claim 1, further comprising a machine-readable memory, wherein the instructions further cause the machine to optionally save one or more masked content descriptions to the memory.

4. The medium of claim 1, wherein the instructions cause the machine to optionally remove one or more selected masked content descriptions and restore the initial content description respectively.

5. The medium of claim 1, wherein the medium is housed in a set top box.

6. The medium of claim 1, wherein at least one of the information masking functions comprises a function to mask the initial content description of a single selected information field.

7. The medium of claim 1, wherein the user interface comprises one or more selectable sets of information fields, and further wherein at least one of the information masking functions comprises a function to mask the initial content descriptions of one or more selected sets of information fields.

8. The medium of claim 1, wherein at least one of the information masking functions comprises a global mask function to mask all the initial content descriptions displayed by the user interface.

9. A system for displaying one or more masked content descriptions in one or more information fields displayed on a terminal, the system comprising:
one or more databases containing initial content descriptions;
user interface logic in communication with one or more of the databases to generate a user interface at a local display, wherein the user interface displays one or more information fields containing one or more of the initial content descriptions, the user interface comprising one or more masking function control elements; and
content description masking logic in communication with the user interface;
wherein the masking logic executes one or more of the masking functions to masked one or more of the initial content descriptions in one or more of the information fields.

10. The system of claim 9, wherein at least one of the following elements of the system is housed in a set-top box: one or more of the databases; the masking logic or the user interface logic.

11. The system of claim 10, wherein at least one of the databases is remote from the set-top box.

12. The system of claim 10, further comprising a set-top box remote control, wherein the user interface accepts masking function control input from the set-top box remote control.

13. The system of claim 9, wherein the terminal comprises a terminal remote from the system.

14. The system of claim 9, wherein the user interface comprises a menu of at least two optionally selectable content description masking functions.

15. A communication network comprising:
one or more information transmission media; and
two or more nodes linked by one or more of the transmission media, wherein at least one of the nodes comprises one or more of the following:
one or more machine-readable media containing logic for content description masking;
one or more machine-readable media containing logic for a user interface for content description masking;
one or more machine-readable databases in communication with the user interface and containing one or more initial content descriptions;
one or more local displays in communication with the user interface logic to display one or more user interfaces for masking one or more content descriptions from one or more of the databases database; and
one or more remote displays to display one or more masked content descriptions.

16. The network of claim 15, wherein one of the nodes comprises a set-top box to house one or more of the content description masking logic; the user interface logic; or one or more of the databases containing one or more of the initial content descriptions.

17. The network of claim 16, further comprising one or more set-top box remote controls to navigate the user interface.

18. A method for masking one or more content descriptions in one or more information fields on one or more displays, the method comprising:
generating at least one user interface on at least one user display, the user interface comprising one or more selectable content description masking functions;
accepting input for one or more of the selectable content description masking functions such that one or more of the selectable content description masking functions is selected;
executing at least one of the selected content description masking functions to create one or more masked content descriptions; and
displaying at least one of the masked content descriptions.

19. The method of claim 18, further comprising saving at least one of the masked content descriptions.

20. The method of claim 18, further comprising restoring at least one masked content description to an unmasked content description.

21. The method of claim 18, further comprising obtaining one or more initial content descriptions from one or more databases containing one or more initial content descriptions in communication with the user interface; wherein one or more of the selected content description masking functions operates on one or more of the initial content descriptions.

22. The method of claim 18, further comprising displaying a menu of one or more content description masking functions in the user interface.
